(19) United States
(12) Patent Application Publication
(10) Pub. No.: US 2022/0302453 A1
(43) Pub. Date: Sep. 22, 2022

(54) COMPOSITE FOR SODIUM BATTERIES

(71) Applicant: AGENCY FOR SCIENCE, TECHNOLOGY AND RESEARCH, Singapore (SG)

(72) Inventors: Yong Sheng Alex Eng, Singapore (SG); Zhi Wei Seh, Singapore (SG)

(21) Appl. No.: 17/626,702

(22) PCT Filed: Aug. 26, 2020
(86) PCT No.: PCT/SG2020/050496

§ 371 Date: Jan. 12, 2022

(30) Foreign Application Priority Data
Aug. 26, 2019 (SG) 10201907874P

(51) Int. Cl. H01M 4/60; H01M 4/36; H01M 4/62; C08F 120/44; H01M 4/38; C08F 8/34; H01M 4/66; H01M 10/44; C01B 32/05

(52) U.S. Cl. CPC H01M 4/604; H01M 4/362; H01M 4/625; C08F 120/44; H01M 4/381; C08F 8/34; H01M 4/661; H01M 10/44; C01B 32/05

(57) ABSTRACT

A carbonized composite comprising a sulfur chain and a conductive network, wherein said sulfur chain is covalently bonded to said conductive network via one or more C—S bonds. The present disclosure also provides a method of preparing the carbonized composite disclosed herein. The carbonized composite may be used in electrochemical cells comprising a reactive metal anode.

### CROSS-REFERENCE TO RELATED APPLICATIONS

This application claims the benefit of priority of Singapore patent application No. 10201907874P, filed on 26 Aug. 2019, its contents being hereby incorporated by reference in its entirety.

### TECHNICAL FIELD

The present invention relates to a conductive composite for use in electrochemical cells, particularly a conductive sulfur composite and methods of preparing thereof, for fabrication of an electrode to be used in electrochemical cells such as sodium batteries

### BACKGROUND ART

With the rapid development of portable and pocket-sized electronic devices, there is an increasing demand for batteries which are able to meet user demands. Lithium-ion technologies have led the way in the development of batteries which are able to sustain portable electronic devices. However, there is growing concern regarding our reliance on lithium metal as an energy storage material, due to the scarcity of lithium in the Earth's crust and its resultant high costs.

Sodium-based batteries have emerged as an alternative energy storage means with the potential to overtake current lithium-ion technologies. In particular, sodium-sulfur batteries which utilize Earth abundant materials, have shown great promise as an alternative and cheaper energy storage means. Such sodium sulfur batteries are typically modelled after the related lithium-sulfur batteries, which commonly use particulate sulfur composites to fabricate cathodes for use with lithium. Yet, particulate sulfur composites which have previously demonstrated stability and compatibility with lithium have been largely ineffective in the sodium-sulfur system. In addition, practical limitations such as the high reactivity of sodium with materials used as the cathode, and the limited stability of reaction intermediates hinder the development of sodium sulfur batteries as an alternative energy storage means.

To overcome these limitations, sulfur composites with various non-particulate morphologies such as fibrous composites and composite webs, have been prepared. However, the preparation of cathodes from such non-particulate composites have proven to be cumbersome due to the need for complex machinery and complex procedures such as electrospinning or thin-film processing. Such methods hinder large scale production of composites for assembly of sodium sulfur batteries. Accordingly, there is a need for sulfur composites, which may be conveniently prepared on an industrial scale.

It is therefore, an object of the invention to provide sulfur composites which are suitable for use with reactive sodium anodes. In particular, it is an object of the present invention to provide conductive sulfur composites which are stable and compatible for use with reactive sodium anodes in a sodium-sulfur battery. It is also desirable to provide methods of preparing such stable sulfur composites, which may be scaled up for industrial purposes.

### SUMMARY OF INVENTION

In one aspect of the present disclosure, there is provided a carbonized composite comprising a) a sulfur chain; and b) a conductive network; wherein said sulfur chain is covalently bonded to said conductive network via one or more C—S bonds; and wherein said composite is substantially free of S₈. In embodiments, the composite may be substantially free of unbonded or unreacted elemental sulfur, S₈.

Advantageously, the carbonized composite which is substantially free of S₈ allows for the fabrication of a cathode which may be sustainably used with reactive metals such as sodium. Cathodes formed from carbonized composites which are substantially free of S₈ demonstrate high Coulombic efficiency of about 99.7% after about 50 cycles, when used with sodium anodes. This is an improvement over cathodes prepared from composites which comprise residual sulfur. The improved Coulombic efficiency indicates that the reactive sodium polysulfide intermediates which are formed in the sodium-sulfur system remain stable during use of the sodium sulfur battery.

Further advantageously, cathodes prepared from the carbonized composite which is substantially free of S₈ demonstrates stable specific capacity, when coupled with a sodium anode. Even after 20 charge and discharge cycles, the sodium-sulfur electrochemical cell demonstrated an average specific capacity of about 1300 mAh·g₍ₛ₎⁻¹. This is a marked improvement over electrochemical cells assembled with composite cathodes comprising residual sulfur, which demonstrate a decrease in capacity to about 400 mAh·g₍ₛ₎⁻¹ after only two cycles of charging and discharging. This is postulated to be due to the formation of long chain polysulfide species which may be irreversibly lost or dissolved in an electrolyte, resulting in an irreversible loss of capacity. Such effects are not observed with cathodes fabricated from the carbonized composites which are substantially free of S₈. The sustained specific capacity demonstrates the potential of the combination of sodium and the carbonized composite described herein to store energy even after extended use.

In another aspect of the present disclosure, there is provided a method of preparing the carbonized composite described herein, the method comprising the steps of a) contacting elemental sulfur and a conductive network precursor to form a mixture; b) heating the mixture obtained in step (a) to form a composite; and c) heating the composite under inert conditions under a temperature sufficient to remove bulk or unbonded sulfur to thereby obtain said carbonized composite.

Advantageously, the method of preparing the carbonized composite as described herein only requires physical grinding and heating to form the carbonized composite. The disclosed methods may facilitate large scale production of the composite due to the ease of synthesis and the lack of solvents or other liquid or aqueous-phase materials for the preparation of the composite.

Further advantageously, the presently disclosed method comprises a second heating step to remove bulk or unbonded sulfur from the composite, thereby facilitating the preparation of the presently disclosed carbonized composites which are substantially free of sulfur, S₈. The removal of residual sulfur advantageously yields composites which demonstrate good average specific capacity of about 1300 mAh·g₍ₛ₎⁻¹ after 20 cycles; and stability when used as a cathode in a sodium-sulfur electrochemical cell. The removal of the residual sulfur may be accomplished via heating only and may exclude the addition of solvents for sulfur removal.

In yet another aspect, there is provided an electrochemical cell comprising a) a sodium anode; b) a cathode comprising the carbonized composite described herein and c) an electrolyte in communication with said sodium anode and cathode.

### Definitions

The term “conductive network” as used herein refers to any material comprising a plurality or series of atoms or moieties which are bonded via covalent linkages. The covalently bound atoms of the conductive network form a delocalized electron system which facilitates charge transfer through the network and confers electrical conductivity. Such conductive networks include 2-dimensional or 3-dimensional arrangements or networks of atoms which may exist in the form of sheets and other forms; and may include materials which possess intrinsic electric conductivity and materials which possess electrical conductivity after being subjected to carbonization, doping or other similar treatment methods.

The term ‘conductive polymer’ as used herein is to be interpreted broadly to refer to any polymer that is able to conduct electricity. This includes polymers which are intrinsically conductive and polymers which are not intrinsically conductive but are treated under specific conditions to confer electrical conductivity. Non-limiting examples of methods to confer electrical conductivity may include such as adding dopant, changing the pH or pyrolysis of the originally non-conductive polymer.

The term ‘conductive network precursor’ as used herein refers to substances which may be used as starting materials to directly form the conductive network via a chemical transformation. Such precursor compounds may be inorganic or organic monomers, oligomers or polymers. The conductive network precursors may or may not possess intrinsic electrical conductivity.

The term ‘monomer’ as used herein refers to a compound which may react chemically with other molecules which may or may not be of the same type to form a larger molecule. Monomers may comprise functional groups capable of forming covalent linkages and reacting with other molecules.

The term “polymer” as used herein refers to compounds which comprise multiple repeating units of a monomer. Polymers may be longer than oligomers and may comprise an infinite number of repeating units of a monomer. Polymers have long chains of repeating units and have high molecular weight.

The term “sulfur chain” as used herein refers to polysulfide groups, moieties or radical species which consist of more than one sulfur atom. Each sulfur atom in the sulfur chain is covalently bonded to another sulfur atom via a S—S bond. The sulfur chain consists of sulfur atoms which may bridge or form a chelate over two or more carbon atoms; and does not comprise atoms of other elements. For example, references to an S₄ sulfur chain indicate that the polysulfide chain consists of four (4) sulfur atoms covalently bonded to each other.

The term “elemental sulfur” as used herein refers primarily to the native form of sulfur, the stable eight-membered orthorhombic sulfur ring, S₈. However, elemental sulfur as defined herein may also refer to any bulk form of sulfur existing in a solid form at room temperature i.e. a temperature of about 20° C. to 30° C. such as 20° C., 25° C., or 30° C.) and atmospheric pressure (about 1 atm).

The term “homogenous” as used herein refers to mixtures which contain a uniform distribution of components throughout. Homogenous mixtures may have the same composition of components throughout. Homogenous mixtures may contain only one phase of matter, e.g. only liquid, solid or gas.

The term “particle diameter” or “particle size” as used herein refers to the diameter of a spherical particle. The particles described herein may be of a regular or irregular shape. Regular shaped particles may be spherical, cylindrical, oblong or ellipse. Where the nanoparticles are not spherical or irregular in shape, the particle diameter shall be taken to be the longest measured diameter of the particle.

The term “carbonizing” or “carbonization” is to be interpreted broadly to refer to a process of converting a carbon-containing substance to a substance comprising primarily carbon. Carbonization of a substance may typically be carried out by heating a carbon-containing substance at a sufficiently high temperature in the absence of air. A substance which has been subjected to a carbonization process is said to have been ‘carbonized’.

The term “particulate” as used in relation to matter, is to be interpreted broadly as clusters or aggregates of more than one particle of a material.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. Exemplary, non-limiting embodiments of a carbonized composite for electrochemical cell electrodes, will now be disclosed

In a first aspect, the present disclosure relates to a carbonized composite comprising a) a sulfur chain; and b) a conductive network, wherein said sulfur chain is covalently bonded to said conductive network via one or more C—S bonds; and wherein said composite is substantially free of elemental sulfur, S₈.

In embodiments, the carbonized composite consists essentially of a) a sulfur chain and b) a conductive network, wherein said sulfur chain is covalently bonded to said conductive network via one or more C—S bonds; and wherein the composite is substantially free of elemental sulfur S₈.

In other embodiments, the carbonized composite consists of a) a sulfur chain and b) a conductive network, wherein said sulfur chain is covalently bonded to said conductive network via one or more C—S bonds; and wherein the carbonized composite is substantially free of elemental sulfur, S₈.

The composite may comprise one or more sulfur chains or a plurality of sulfur chains. The sulfur chain may be covalently bonded to said conductive network via one or more C—S bonds, or preferably two or more C—S bonds, or a plurality of C—S bonds. The sulfur chain may be covalently bonded to said conductive network via 2-7 C—S bonds, or 2-6 C—S bonds, or 2-5 C—S bonds, or preferably 1-4 C—S bonds.

The sulfur chain may comprise less than 8 sulfur atoms. The sulfur chain which is covalently bonded to the polymer backbone via one or more C—S bonds may comprise 2-7 sulfur atoms, or 2-6 sulfur atoms, or 2-5 sulfur atoms; or preferably 2-4 sulfur atoms. The sulfur chain of the carbonized composite may be present in the form of S₂, S₃, S₄, S₅, S₆ or S₇; or in the form of S₂, S₃, S₄, S₅ or S₆; or in the form of S₂, S₃, S₄, or S₅; or preferably in the form of S₂, S₃, or S₄. In embodiments, the sulfur chain of the composite disclosed herein comprises S₂—S₄ chains.

The presence of sulfur chains of less than 8 sulfur atoms in the composite may be inferred from the presence of S—S stretches in the infrared spectrum, in addition to the lack of X-ray diffraction patterns which correspond to the orthorhombic S₈ group. Further, peaks corresponding to S₈ fragments were also substantially absent in the time-of-flight mass spectrometry, indicating the absence of S₈ chains. When used for fabrication of a cathode in an electrochemical cell, the absence of a small initial plateau at a high initial voltage in the first discharge cycle of the electrochemical cell is also indicative of the absence of S₈ chains in the composite.

Sulfur chains of about 2-4 atoms in length contribute to at least 75 wt. % of all sulfur chains in the composite, or about 80 wt. % of all sulfur chains in the composite, or about 90 wt. % of all sulfur chains in the composite, or about 92 wt. % of all sulfur chains in the composite, or about 94 wt. % of all sulfur chains in the composite, or about 96 wt. % of all sulfur chains in the composite, or about 98 wt. % of all sulfur chains in the composite, or about 99 wt. % of all sulfur chains in the composite, or about 99.5 wt. % of all sulfur chains in the composite, preferably about 99.9 wt. % of all sulfur chains in the composite. In embodiments, at least 99.9 wt % of all sulfur chains in the composite comprised 2-4 sulfur atoms. This is evidenced from the low amounts of S₅-S₇ fragments of less than 0.1 wt. %, as observed in the mass spectrum of the composite.

Advantageously, sulfur chains of about 2-4 sulfur atoms in the composite leads to the formation of stable polysulfide species when the composite is used as a cathode in a sodium-sulfur electrochemical cell. The formation of stable sodium polysulfide species contributes to good charge retention of a sodium-sulfur battery, as demonstrated by the Coulombic efficiency of about 99.7% maintained after 50 cycles and average specific capacity of about 1300 mAh·g₍ₛ₎⁻¹, even after 20 cycles of charge and discharge. This indicates that composites comprising a sulfur chain of about 2-4 atoms contribute to a stable and sustained performance of an electrochemical cell.

Other forms or allotropes of sulfur are not present in the composite. The composite may be substantially free of long sulfur chains of 8 or more sulfur atoms. The composite may be substantially free of S₈.

The composite may comprise less than 0.1 wt. % of S₈ by total weight of the composite, or less than about 0.05 wt. % of S₈ by total weight of the composite, or less than 0.01 wt. % of S₈ by total weight of the composite, or less than 0.005 wt. % of S₈ by total weight of the composite, or preferably less than 0.001 wt % of S₈ by total weight of the composite, more preferably 0 wt % of S₈ by total weight of the composite.

The claimed composite, which is substantially free of S₈, advantageously provides a composite for fabrication of a stable cathode which may be used with a sodium anode in an electrochemical cell. In particular, a sodium sulfur electrochemical cell comprising a cathode made from the claimed composite advantageously demonstrates high cycling capacities, with high Coulombic efficiencies of close to 100%, indicating good stability of the sodium polysulfide intermediates in the presence of reactive sodium metal.

The conductive network of the carbonized composite may comprise a plurality of atoms which are covalently bonded. The conductive network comprises one or more sp²-hybridized atoms. In embodiments, the conductive network comprises a plurality of sp² hybridized atoms.

The conductive network may be based on carbon or silica, preferably carbon. In embodiments, the conductive network is a carbon-based conductive network. The conductive network may comprise a conjugated system. The conjugated system may comprise a series of alternating double and single bonds which provides a delocalized electron system. The conductive network may comprise a series of double bonds which forms the conjugated system. The conductive network may comprise one or more of C═C, C═N, C═O or C═S double bonds, preferably C═C and C═N double bonds. In embodiments, the conductive network comprises a plurality of C═C and C═N double bonds.

The composite may be provided in the form of particulate clusters, or clusters of particles. Each particle of the cluster has a particle size or particle diameter of about 1 μm or less, or about 50 nm to 1000 nm, or about 50 to 950 nm, or about 50 nm to 900 nm, or about 50 nm to 850 nm, or about 50 nm to 800 nm, or about 50 nm to 750 nm, or about 50 nm to 700 nm, or about 50 nm to 650 nm, or about 50 nm to 600 nm, or about 50 nm to 550 nm, or about 50 nm to 500 nm, or about 50 nm to 450 nm, or about 50 nm to 400 nm, or about 50 nm to 350 nm, or about 50 nm to 300 nm, or about 50 nm to 250 nm, or about 50 nm to 200 nm, or preferably about 100 nm to 200 nm. Preferably, the average particle diameter of the composite is about 200 nm.

Advantageously, the particulate nature of the composition allows for more simple and convenient preparation of a cathode for an electrochemical cell. Using the particulate composite, a cathode may be prepared by conventional methods such as applying a slurry comprising the composite on a conductive substrate such as an aluminium sheet. The sheet may be subsequently dried and used in an electrochemical cell. This avoids the need for more complex and cumbersome electrode preparation methods such as electrospinning or thin film processes.

The carbonized composite as described herein may have a sulfur content of about 20-50 wt. % by total weight of the composite, or about 20-45 wt. % by total weight of the composite, or about 20-40 wt. % by total weight of the composite, or about 25-40 wt. % by total weight of the composite, or about 30-40 wt. % by total weight of the composite, or about 30-38 wt. % by total weight of the composite, or preferably about 30-36 wt. % by total weight of the composite. In embodiments, the sulfur content of the composite is about 33-36 wt. % by total of the composite.

The carbonized composite described herein may have a carbon content of about 20 to 50 wt. % based on the total weight of the composite, or about 20 to 45 wt. % based on the total weight of the composite, or about 20 to 40 wt. % based on the total weight of the composite, or about 25 to 40 wt. % based on the total weight of the composite, or preferably about 30 to 40 wt. % based on the total weight of the composite, or more preferably about 33 to 38 wt. % based on the total weight of the composite. In embodiments, the carbon content of the carbonized composite is about 32 to 35 wt. % based on the total weight of the composite.

The carbonized composite described herein may have a nitrogen content of about 10 to 40 wt. % based on the total weight of the composite, or about 10 to 35 wt. % based on the total weight of the composite, or about 10 to 30 wt. % based on the total weight of the composite, or about 10 to 25 wt. % based on the total weight of the composite, or about 10 to 20 wt. % based on the total weight of the composite, or about 10 to 18 wt. % based on the total weight of the composite, or preferably about 12 to 18 wt. % based on the total weight of the composite. In embodiments, the nitrogen content of the composite is about 12 to 17 wt. % based on the total weight of the composite. In preferred embodiments, the nitrogen content of the composite is about 13-16 wt. % based on the total weight of the composite.

The carbonized composite as described herein may have a hydrogen content of less than or equal to 1 wt. %, or about 0.05 to about 0.95 wt. % based on the total weight of the composite, or about 0.05 to about 0.90 wt. % based on the total weight of the composite, or about 0.05 to about 0.85 wt. % based on the total weight of the composite, or about 0.05 to about 0.80 wt. % based on the total weight of the composite, or about 0.05 to about 0.75 wt. % based on the total weight of the composite, or about 0.05 to about 0.7 wt. % based on the total weight of the composite, or about 0.1 to about 0.7 wt. % based on the total weight of the composite, or about 0.15 to about 0.7 wt. % based on the total weight of the composite, or about 0.2 to about 0.7 wt. % based on the total weight of the composite, or about 0.25 to about 0.7 wt. % based on the total weight of the composite, or preferably about 0.3 to about 0.7 wt. % based on the total weight total weight of the composite. In embodiments, the hydrogen content of the carbonized composite is about 0.32 to 0.7 wt. %, based on the total weight of the composite.

The carbonized composite of the present disclosure may be prepared or obtained by the method described herein. In another aspect, there is provided a method of preparing the carbonized composite described herein. The method comprises the steps of a) contacting elemental sulfur and a conductive network precursor to form a mixture; b) heating the mixture obtained from step a) to form a composite; and c) heating the composite under inert conditions under a temperature sufficient to remove bulk or unbonded sulfur to thereby obtain said carbonized composite.

The step of contacting elemental sulfur and the conductive network precursor may be carried out in the absence of any solvents. The contacting step (a) may be carried out by physically blending, stirring, shearing, grinding or milling the reactants to form a homogenous solid mixture. In embodiments, a mixture of the elemental sulfur and conductive polymer precursor is formed by grinding the reactants.

The grinding process advantageously aids in reducing the particle size of both elemental sulfur and the conductive network precursor. This yields a homogenous mixture comprising particles of elemental sulfur and conductive network precursor with reduced and uniform sizes; and contributes to the formation of carbonized composites having a particulate nature, without the need of solvents and other liquid phase reagents.

The conductive network precursor and elemental sulfur may be contacted at a weight ratio of about 1:2 to 1:10, or about 1:2 to 1:9, or about 1:2 to 1:8, or about 1:2 to 1:7, or about 1:2 to 1:6, or about 1:2 to 1:5, or preferably about 1:3 to 1:5. In preferred embodiments, the ratio of the conductive network precursor to elemental sulfur is about 1:3.

The conductive network precursor may be any compound, substance or material which may be used to form the conductive network of the carbonized composite described herein. The conductive network precursor may be an inorganic or organic compound or complex. The conductive network precursor may be an organic monomer, oligomer or polymer, optionally substituted with one or more functional groups. In embodiments, the conductive network precursor is a polymer.

The polymer used as the conductive network precursor may have an average molecular weight of about 100,000 g/mol to about 500,000 g/mol, or about 100,000 to about 450,000 g/mol, or about 100,000 to about 400,000 g/mol, or about 100,000 to about 350,000 g/mol, or about 100,000 to about 300,000 g/mol, or about 100,000 to about 250,000 g/mol, or about 100,000 to about 200,000 g/mol, or about 100,000 to about 180,000 g/mol, preferably about 120,000 to about 180,000 g/mol. In embodiments, the molecular weight of the polymer is about 150,000 g/mol.

The conductive network precursor may be a polymer comprising one or more types of monomer units. The monomer units of the polymer may be optionally substituted with one or more functional groups. In embodiments, the conductive polymer precursor comprises functionalized monomer units.

The functional groups of the monomer units may be nitrile, amine, carboxyl or thiocarbonyl groups, preferably nitrile groups. In embodiments, the conductive network precursor is a polymer comprising nitrile-functionalized monomer units. Advantageously, the presence of the nitrile-functionalized monomer units allows the formation of a composite comprising a conjugated conductive network having C═N groups. The presence of the C═N groups may interact with reactive metal anodes such as a sodium anode, which contributes to the stabilization of an electrochemical cell.

The monomer units may also comprise 2-20 carbon atoms, in addition to the nitrile functional group. The monomer unit may comprise 2-20 carbon atoms, or 2-18 carbon atoms, or 2-16 carbon atoms, or 2-14 carbon atoms, or 2-12 carbon atoms, or 2-10 carbon atoms, or 2-9 carbon atoms, or 2-8 carbon atoms, or 2-7 carbon atoms, or 2-6 carbon atoms, or 2-5 carbon atoms, or 2-4 carbon atoms, preferably 2-3 carbon atoms. In embodiments, the monomer unit comprises 2 carbon atoms, in addition to the nitrile functional group of the monomer unit.

The nitrile-functionalized monomer units in the polymer may be acrylonitrile or methacrylonitrile. In embodiments, the nitrile-functionalized monomer unit is acrylonitrile.

The polymer used as the conductive network precursor may be a homopolymer or co-polymer comprising nitrile-functionalized monomer units. The co-polymer may be a linear co-polymer, or branched co-polymer, or block co-polymer of the nitrile-functionalized monomeric unit. The polymer used in the carbonized composite may be polyacrylonitrile, poly(acrylonitrile-butadiene) co-polymer, poly(acrylate-styrene-acrylonitrile) co-polymer, poly(acrylonitrile-butadiene-styrene) co-polymer or poly(styrene-acrylonitrile) co-polymer. In embodiments, the polymer is polyacrylonitrile.

The mixture obtained from the grinding process may be subsequently heated to carbonize the mixture. The heating of the mixture obtained from step (a) may be carried out under inert conditions to form the composite. In embodiments, the first heating step (b), also referred to as the carbonization step is carried out under an inert atmosphere such as an Argon atmosphere in an autoclave.

The first heating step may be carried out for a period of about 2 to 10 hours, or about 2 to 9 hours, or about 2 to 8 hours, or about 2 to 7 hours, or about 3 to 7 hours, or about 4 to 7 hours, or preferably about 5 to 7 hours. In embodiments, the first heating step is carried out for 6 hours.

Without being bound by theory, the heating step carbonizes the mixture and allows the formation of a conductive composite. The heating or carbonization of the composite leads to the reactions such as cyclization, dehydrogenation and reduction of the conductive network precursor, leading to the formation of a sp² hybridized conjugated carbon network in the composite.

In addition, the carbonization of the mixture also allows the formation of covalent bonds, C—S bonds and the cleavage of elemental sulfur to form shorter sulfur chains of less than 8 sulfur atoms, preferably 2 to 4 sulfur atoms. The formation of the covalent C—S bonds also facilitates the formation of the network of C═C and C═N bonds in the obtained composite, which, along with the binding of sulfur to the hybridized network, confers electrical conductivity to the composite. The electrical conductivity of the composite enables it to be used for the preparation of electrodes of an electrochemical cell.

The heating step (b) may be carried out at a temperature of about 250° C. to 600° C., or about 280° C. to 600° C., or about 300° C. to 600° C., or about 320° C. to 600° C., or about 350° C. to 600° C., or about 380° C. to 600° C., or about 400° C. to 600° C., or about 420° C. to 600° C., or about 450° C. to 600° C., or about 480° C. to 600° C., or about 500° C. to 600° C., or about 520° C. to 600° C., or about 520° C. to 580° C., or about 530° C. to 580° C., or about 540° C. to 580° C., or preferably about 540° C. to 560° C. In embodiments, the heating step (b) was carried out at a temperature of about 550° C.

Advantageously, carbonization of the composite at a temperature of about 550° C. leads to the formation of a more extensive sp² conjugated network in the composite, which contributes the improved electrical properties of electrodes formed from the composite. The formation of the more extensive sp²-conjugated network is evidenced by the less intense C—C single bond deformation absorptions at 1360 cm⁻¹, relative to the C═C and C═N absorptions observed in the infrared spectrum of the composites carbonized at 550° C. In contrast, such C—C single bond deformation absorptions at 1360 cm⁻¹ are clearly observed for composites carbonized at 350° C. and 450° C. In addition, the hydrogen content of composites carbonized at 550° C. is lower than that of composites carbonized at temperatures of 350° C. and 450° C. The lower hydrogen content and less intense C—C deformation absorptions indicate that a greater extent dehydrogenation, and consequently, formation of an extended sp²-hybridized conductive network is obtained during carbonization of the composite at 550° C.

The more extensive sp² conjugated network observed for composites carbonized at 550° C. advantageously allows for the fabrication of cathodes which demonstrate good stability and specific capacity when used in a sodium sulfur electrochemical cell. Despite the lower sulfur content, electrodes formed from composites carbonized at 550° C. demonstrated a Coulombic efficiency of 99.7% even after 50 cycles. This indicates that the cathode made from the carbonized composite described herein is able to form stable sodium polysulfide species even in the presence of highly reactive sodium metal anode.

Without being bound by theory, the carbonization of a mixture of sulfur and a network precursor comprising nitrile-functionalized monomers leads to the formation of a highly conductive network. The presence of the nitrile group leads to the formation of a conductive network comprising one or more C═C and C═N bonds, upon carbonization. When used for the preparation of a cathode in an electrochemical cell, the presence of the C═N group in the conductive network provides a lone pair of electrons which may interact with, and stabilize sodium polysulfide species formed during cycling of an electrochemical cell. Such sodium polysulfide species are important to the retention of charge in an electrochemical cell and its stabilization prevents irreversible dissolution or loss of the polysulfide species to the electrolyte. This advantageously improves the stability of the anode-cathode pair, and the composite may advantageously be suitable and compatible with a reactive metal anode in an electrochemical cell.

After the first heating step (b), and before the second heating step (c), the composite may be allowed to cool to room temperature. The cooling may be conducted, with or without the use of coolers or ice baths. In embodiments, the composite is allowed to cool to room temperature naturally, under ambient conditions.

Upon cooling, the composite formed from step (b) may be heated again under inert conditions under a temperature sufficient to remove bulk or unbonded sulfur to thereby obtain the carbonized composite described herein. The second heating step (c) is carried out to remove unreacted elemental sulfur, S₈ from the composite.

The second heating step may be carried out at a lower temperature as compared to the first step. The second heating step may be carried out at a temperature which is sufficient to remove the unreacted, excess S₈, but does not decompose the composite. The second heating step (c) may be carried out at a temperature of about 100° C. to 500° C., or about 100° C. to 480° C., or about 100° C. to 450° C., or about 100° C. to 420° C., or about 100° C. to 400° C., or about 100° C. to 380° C., or about 100° C. to 350° C., or about 100° C. to 320° C., or about 100° C. to 300° C., or about 100° C. to 280° C., or about 120° C. to 280° C., or about 150° C. to 300° C., or about 150° C. to 280° C., or about 180° C. to 280° C., or about 200° C. to 280° C., or about 220° C. to 280° C., or about 220° C. to 260° C., or preferably about 240° C. to 260° C. In embodiments, the second heating step is carried out at a temperature of about 250° C.

The second heating step may be carried out under inert conditions, in the presence of a continuous inert gas flow. Without being bound by theory, when the composite is heated, excess or unreacted elemental sulfur, S₈, is sublimed and the continuous flow of inert gas helps to remove the vapor which is produced. In embodiments, the second heating step is carried out in a tube furnace under a continuous flow of Argon or other equivalent inert gases.

The second heating step may be carried out for a period of time sufficient for complete removal of excess, unreacted S₈. The second heating step may be carried out for about 1 to 6 hours, or about 1 to 5 hours, or about 1 to 4 hours, or preferably for about 1 to 3 hours. In embodiments, the second heating step may be carried out for about 2 hours.

The carbonized composites described herein may be used for the preparation of electrodes such as a cathode for an electrochemical cell. The present disclosure also provides electrodes, preferably cathodes, prepared using the carbonized composites described herein. The electrode may be prepared by mixing the carbonized composite described herein with a polymer binder and conductive carbon material in a solvent to yield a slurry; spreading a uniform layer of the slurry on a conductive substrate; and drying the coated substrate at a temperature sufficient to evaporate the solvent. The preparation of the cathode according to the methods as described herein yields a non-porous cathode which may be used in electrochemical cells such as sodium-sulfur batteries.

The mixing may be carried out by stirring, blending, grinding, milling, shearing and other physical mixing methods. In embodiments, the mixture of the polymer binder, carbonized composite and conductive carbon material was mixed by grinding.

The prepared electrode may comprise a polymer binder. The weight ratio of the polymer binder to the carbonized composite may be about 1:1 to about 1:15, or about 1:1 to about 1:12, or about 1:1 to about 1:10, or about 1:2 to about 1:10, or about 1:5 to about 1:10, or about 1:5 to about 1:8, or preferably about 1:6 to about 1:8. In embodiments, the ratio of the polymer binder to the carbonized composite is about 1:7.

The polymer binder of the electrode may function to bind the carbonized composite and conductive carbon to form a solid electrode. The polymer binder may be carboxymethyl cellulose, sodium carboxymethyl chitosan, sodium alginate, styrene butadiene rubber, polyvinylidene fluoride or other similar binders. In embodiments, the polymer binder is polyvinylidene fluoride.

The cathode may also be prepared with conductive powders such as conductive carbon. The weight ratio of the conductive powder to the carbonized composite may be about 1:1 to about 1:10, or about 1:1 to about 1:9, or about 1:1 to about 1:8, or about 1:1 to about 1:7, or about 1:1 to about 1:6, or about 1:1 to about 1:5, or preferably about 1:2 to about 1:5. In embodiments, the ratio of the conductive powder to the carbonized composite is about 1:3.5. In other embodiments, the cathode was prepared by mixing the composite with conductive carbon and polymer binder at a weight ratio of about 7:2:1.

The solvent used for the preparation of the slurry may be any solvent which dissolves the polymer binder so the carbonized composite and conductive carbon may be bound in the electrode when said solvent is removed. The solvent may be a polar or non-polar solvent, preferably a polar solvent. The solvent may be any solvent which may be evaporated at temperatures of less than 250° C. The solvent may have a boiling point of less than 250° C. The solvent may be dimethylformamide, acetone, methanol, ethanol, dimethylsulfoxide, p-xylene, toluene, N-methyl-2-pyrrolidone or dimethylacetamide. In embodiments, the solvent is N-methyl-2-pyrrolidone.

The conductive substrate used for the preparation of the electrode may be a sheet made from any conductive material. The conductive substrate may be made of material which does not interfere with the electrochemical behavior of the composite. The conductive substrate may be made from aluminium, copper, silver, gold, zinc, nickel, platinum or steel. In embodiments, the conductive substrate is made from aluminium.

The drying of the electrode may be carried out at a temperature sufficient to evaporate the solvent, without decomposition of the electrode. The drying of the electrode may be carried out at temperatures of about 50° C. to 200° C., or about 50° C. to 180° C., or about 50° C. to 160° C., or about 50° C. to 140° C., or about 50° C. to 120° C., or about 50° C. to 100° C., or about 50° C. to 90° C., or about 60° C. to 90° C., or preferably about 60° C. to 80° C. In embodiments, the electrode may be dried at a temperature of 70° C.

Upon drying, a non-porous electrode may be obtained. The areal sulfur load of the cathode is about 0.2-1.2 mg₍ₛ₎·cm⁻², or about 0.2-1.1 mg₍ₛ₎·cm⁻², or about 0.2-1.0 mg₍ₛ₎·cm⁻², or about 0.2-0.9 mg₍ₛ₎·cm⁻², or about 0.2-0.8 mg₍ₛ₎·cm⁻², or about 0.2-0.7 mg₍ₛ₎·cm⁻², or about 0.2-0.6 mg₍ₛ₎·cm⁻², or preferably about 0.3-0.6 mg₍ₛ₎·cm⁻². In embodiments, the areal sulfur loading of the cathode is about 0.4-0.6 mg₍ₛ₎·cm⁻²,

The electrode prepared using the methods described herein may be used in an electrochemical cell. The electrode may preferably be a cathode. The cathode prepared according to the methods described herein may be used in a sodium-based electrochemical cell. The cathode prepared according to the methods described herein may be used in a sodium-based electrochemical cell which is operable and stable at room temperature.

In yet another aspect of the present disclosure, there is provided an electrochemical cell comprising a) a sodium anode; b) a cathode comprising the carbonized composite described herein; and c) an electrolyte. The electrolyte may be in communication with said sodium anode and cathode. The electrochemical cell as described herein is operable at room temperature, without the need for external heating.

The electrolyte used in the electrochemical cell may be a solid or liquid electrolyte. When a liquid electrolyte is provided, an absorbent, inert material may be immersed in the electrolyte, and used for assembly of an electrochemical cell. In embodiments, a membrane is immersed in an electrolyte and contacted with the anode and cathode of the electrochemical cell.

The electrolyte may comprise one or more organic solvents. The electrolyte may be substantially free of water. The electrolyte may be an ether-based solvent, a carbonate-based solvent or a mixture thereof, preferably a carbonate-based solvent. The electrolyte may comprise ethylene carbonate, fluoroethylene carbonate, vinylene carbonate, propylene carbonate, diethyl carbonate, dibenzyl carbonate, diallyl carbonate, diphenyl carbonate, dipropyl carbonate dimethyl carbonate tetraglyme, monoglyme, diglyme, or mixtures thereof. In embodiments, the electrolyte of the electrochemical cell is a 1:1 volume/volume (v/v) mixture of ethylene carbonate and diethyl carbonate.

Advantageously, the use of carbonate-based solvents of a mixture thereof result in good capacity retention and stable charge and discharge profiles. Electrochemical cells which utilize such solvents or combinations thereof show an average Coulombic efficiency of about 99.5% over 30 cycles.

The electrolyte may also comprise ionic salts which facilitate charge transfer between the anode and cathode. Such ionic salts may comprise a cation of the anode. In embodiments, the ionic salt is a sodium-based salt. The salts may comprise a polyatomic anion. The salt may be sodium trifluoromethanesulfonate (OTf), sodium bis(fluorosulfonylimide) (FSI), sodium trifluoromethanesulfonimide, sodium perchlorate, sodium bisfluorosulfonylamide or mixtures thereof. In embodiments, the ionic salt is sodium trifluoromethanesulfonate.

The ionic salts in the electrolyte may be provided at a concentration of about 0.2-2.0 M, or about 0.2-1.8 M, or about 0.2-1.6 M, or about 0.2-1.4 M, or about 0.2-1.2 M, or about 0.4-1.2 M, or about 0.6-1.2 M, or preferably about 0.8-1.2 M. In embodiments the salt is provided at a concentration of about 1.0 M.

As described herein, there is provided a carbonized composite and methods of preparing thereof. The disclosed carbonized composite may be used for the fabrication of cathodes which demonstrate good stability, capacity and compatibility with reactive metal anodes in an electrochemical cell. The methods described herein also provide a facile and convenient method for preparing composites which may be used in an electrochemical cell.

### BRIEF DESCRIPTION OF THE DRAWINGS

The accompanying drawings illustrate disclosed embodiments and serve to explain the principles of the disclosed embodiments. It is to be understood that the drawings are for purposes of illustration only and not as a definition of the limits of the invention.

FIG. 1 is a schematic illustration of a fabricated sodium sulfur battery comprising a sodium sheet as an anode and a sulfur-polyacrylonitrile composite cathode. The sodium sulfur battery of FIG. 1 was fabricated as a coin type cell. The illustrated electrochemical cell comprises a sodium anode and a cathode comprising the carbonized composite described herein coated on a conductive substrate. The sodium anode and cathode are separated by a porous membrane immersed in a suitable electrolyte which facilitates charge transfer.

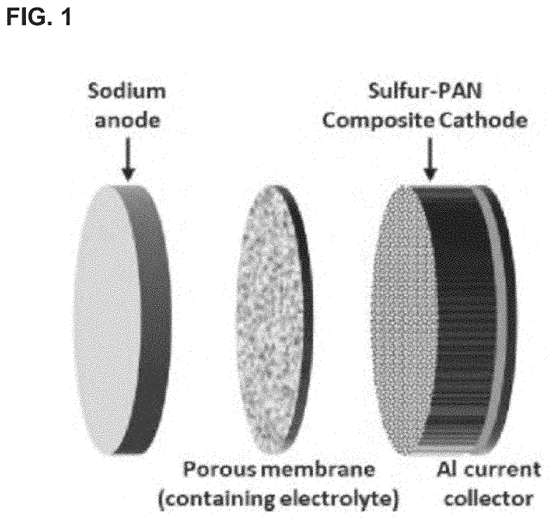

FIGS. 2A, 2B, and 2C are a series of scanning electron micrographs of sulfur-polyacrylonitrile composites prepared by performing the first heating step at a temperature of A) 350° C., B) 450° C. and C) 550° C. The initial weight ratios of sulfur:polyacrylonitrile, which are used for the preparation of the composites is indicated in parentheses. The scanning electron micrographs demonstrate that the composite exists as clusters of globular or spherical particles, each particle having a diameter of less than 1 μm. Scale bars are drawn at 1 μm.

FIGS. 3A, 3B, and 3C are a series of Fourier Transform Infrared Spectroscopy (FTIR) spectra of sulfur-polyacrylonitrile composites prepared at A) 350° C., B) 450° C. and C) 550° C. The weight ratio of sulfur to polyacrylonitrile is indicated in parenthesis in each FTIR spectra. The absorptions at about 1500 cm⁻¹ and about 1550 cm⁻¹ corresponds to the symmetric and asymmetric stretches of the C═C double bond; while the absorptions at about 1240 cm⁻¹ and 1430 cm⁻¹ correspond to the symmetric and asymmetric stretches of the C═N bond. The presence of absorption bands at about 668 cm⁻¹ correspond to C—S stretching modes which indicate that covalent C—S bonds are formed between the conductive network and sulfur chain. For clarity, the absorptions at about 2300 cm⁻¹ to 2400 cm⁻¹ correspond to the symmetric and asymmetric stretches of carbon dioxide which exists in the background.

FIG. 4A is a thermogravimetric analysis graph of composites prepared by conducting the first heating step at a temperature of 550° C. with an initial sulfur:polyacrylonitrile weight ratio of 3:1. The composite demonstrated good thermal stability up to about 650° C. before decomposing. This indicates the absence of elemental sulfur, S₈, which is known to decompose at a temperature of 300° C. FIG. 4B (top) is a X-ray diffraction spectrum of the sulfur-polyacrylonitrile composite prepared from an initial 3:1 weight ratio of sulfur:polyacrylonitrile, and carbonized at a temperature of 550° C. The X-ray diffraction pattern of the composite displayed a broad peak at about 26°, characteristic of graphitized carbons. The X-ray diffraction pattern of elemental orthorhombic sulfur, S₈, is also shown for comparison (bottom). Peaks corresponding to free orthorhombic sulfur S₈ are not observed in the diffraction pattern of the composite, indicating the absence of S₈. This also indicates that sulfur in the composite is bonded to the carbon-nitrogen conductive network.

FIGS. 5A and 5B demonstrate the performance of a battery prototype prepared with a sulfur polyacrylonitrile composite cathode with a pure sodium anode, with a 1 M sodium trifluoromethanesulfonate (NaOTf) electrolyte dissolved in a 1:1 volume/volume mixture of ethylene carbonate and diethyl carbonate. FIG. 5A shows the galvanostatic charge/discharge cycling curves at 0.2C, of a cathode comprising a sulfur-polyacrylonitrile composite prepared from an initial 3:1 weight ratio of sulfur:polyacrylonitrile, and carbonized at a temperature of 550° C. The discharge cycles began at about 2.1 V against the Na/Na⁺ electrode and the capacity of the cathode was found to have stabilized by the tenth charge/discharge cycle at about 1350 mAh·g₍ₛ₎⁻¹ of about. FIG. 5B shows the cycling performance of a sulfur polyacrylonitrile composite cathode produced from an initial 3:1 weight ratio of sulfur:polyacrylonitrile, and carbonized at a temperature of 550° C. The average Coulombic efficiency of the cathode is about 99.6% after about 30 cycles, indicating good stability of the intermediate polysulfide species even in the presence of a highly reactive sodium metal anode.

FIGS. 6A and 6B show two scanning electron micrographs of sulfur-polyacrylonitrile composites. FIG. 6A is a scanning electron micrograph of a sulfur-polyacrylonitrile composite prepared with a second heating step to remove residual sulfur. FIG. 6B is a scanning electron micrograph of a sulfur-polyacrylonitrile composite prepared without a second heating step. The composite of FIG. 6b therefore comprises residual sulfur S₈. Scale bars are at 1 μm.

FIGS. 7A, 7B, and 7C compare the performance of a composite cathode prepared with the second heating step to remove sulfur (referred to as the “evaporated” sample), and without the heating step to remove sulfur (referred to as the “unevaporated” sample). Both the “evaporated” and “unevaporated” samples were prepared from an initial 3:1 sulfur:PAN weight ratio and carbonized at 550° C. A sodium-sulfur electrochemical cell was assembled using a cathode prepared with the “evaporated” and “unevaporated” sulfur-polyacrylonitrile composites. FIG. 7A shows the galvanostatic charge/discharge curves of the cell assembled with a cathode comprising the “evaporated” composite cathode. FIG. 7B shows the galvanostatic charge/discharge curves of the electrochemical cell assembled with a cathode comprising the “unevaporated” composite cathode. The discharge curves of FIG. 7B show a large decrease in capacity to below 400 mAh·g₍ₛ₎⁻¹ from the second cycle and an unstable voltage profile was observed in subsequent recharge cycles. FIG. 7C shows the Coulombic efficiencies of the sodium sulfur cells fabricated with cathodes prepared with the “evaporated” and “unevaporated” composites.

FIGS. 8A and 8Ba are plots summarizing the different molecular species present in the composite, obtained using time of flight secondary ion mass spectrometry methods. The plots illustrate the relative amounts of sulfur species and covalently bonded carbon-sulfur species present in an “ionized” sample of the sulfur-polyacrylonitrile composite cathode. The total counts of detected species are tabulated on a logarithmic intensity axis. FIG. 8A shows the relative amounts of sulfur chain fragments detected, with the majority of sulfur chains existing as short chain species, primarily S₂, S₃ and S₄ chains. FIG. 8B demonstrates the relative contents of carbon fragments and carbon-sulfur species of varying lengths. These carbon-sulfur species further confirm covalent bonding between carbon and sulfur atoms in the composite.

### EXAMPLES

Non-limiting examples of the invention will be further described in greater detail by reference to specific Examples, which should not be construed as in any way limiting the scope of the invention.

### General Experimental Section

Elemental combustion analysis was done on a Thermo Scientific Flash 2000 analyzer, with each sample individually sealed in a tin-foil capsule. Sulphanilamide was used as the analytical standard (Elemental Microanalysis, UK) for calibration. Scanning electron microscopy was completed on a JEOL 7600F field emission scanning electron microscope (JEOL, Japan) with samples directly mounted on a sample holder with conductive copper tape. FTIR spectra were obtained in transmittance mode on a Spectrum 2000 instrument (Perkin Elmer). Thermogravimetric analysis was performed on a TA Instruments Q500, using a temperature ramp rate of 10° C. min⁻¹, under nitrogen gas flow. Powder X-ray diffraction was done using a Bruker D8 ADVANCE X-ray diffractometer, using a Cu Kα source at λ=1.5406 Å. Time of flight secondary ion mass spectrometry measurements were obtained with a TOF.SIMS 5 instrument (IONTOF, Germany) using a Bismuth primary ion beam at 30 keV, over a sample area of 100×100 μm.

### Example 1

### Gram-Scale Syntheses of Sulfur-Polyacrylonitrile Composites

The following outlines a process for the simplified gram-scale synthesis of particulate sulfur-polyacrylonitrile composites. The method described herein comprises three steps.

Elemental sulfur and polyacrylonitrile (PAN; average molecular weight=150,000 g mol-1) were first mixed by physical grinding in an agate mortar and pestle (sulfur:PAN weight ratios of 3:1, 4:1, or 5:1) for approximately ten minutes, to yield a fine light yellow powder. The ground sulfur-PAN mixtures (5 g each) were subsequently transferred into stainless steel autoclaves and sealed in an Argon-filled glovebox. Each autoclave was then removed and heated to 350° C., 450° C., or 550° C. from room temperature at a heating rate of 10° C. min⁻¹, and held for 6 hours before being allowed to cool naturally. Typical yields of S-PAN composites are in the gram scale, ranging from approximately 3 g to 4 g. Finally, the black carbonized powders were transferred to alumina boats and placed in a tube furnace (Argon-flow rate of 100 sccm, heating rate of 10° C. min⁻¹) maintained at 250° C. for 2 hours for removal of unreacted sulfur.

### Example 2

### Characterization of Sulfur-PAN Composites

The following describes the properties and chemical natures of Sulfur-PAN composites produced from the invented process. Composites were synthesized based on the described method in Example 1, at varying temperatures and initial weight ratios of sulfur:PAN at 3:1, 4:1, or 5:1.

Morphologies of the composites produced were first examined through microscopy, and found to have a particulate nature. Although composites with particulate morphologies have been applied in lithium-sulfur battery systems, they have not yet been employed with sodium-sulfur batteries as presented here.

Consequently, the chemical structure of the composites were probed with Fourier-transform infrared (FTIR) spectroscopy specifically to identify covalent bonding between sulfur as active species and the polymer framework, and conjugation within the carbon backbone, conferring chemical stability and electrical conductivity respectively.

Finally, while sulfur is the active species exploited in the sodium-sulfur battery system, it should not exist freely/unbound in its elemental form (i.e. orthorhombic sulfur, S₈), due to detrimental effects associated with its high reactivity with sodium in the cell environment. To this end, time-of-flight secondary ion mass spectrometry was used to determine its absence, in addition to thermogravimetric analysis and X-ray diffraction. Elemental combustion analysis was also carried out to determine the total sulfur content present in the composite, for all forms of sulfur.

### Morphology of Sulfur-Polyacrylonitrile Composites

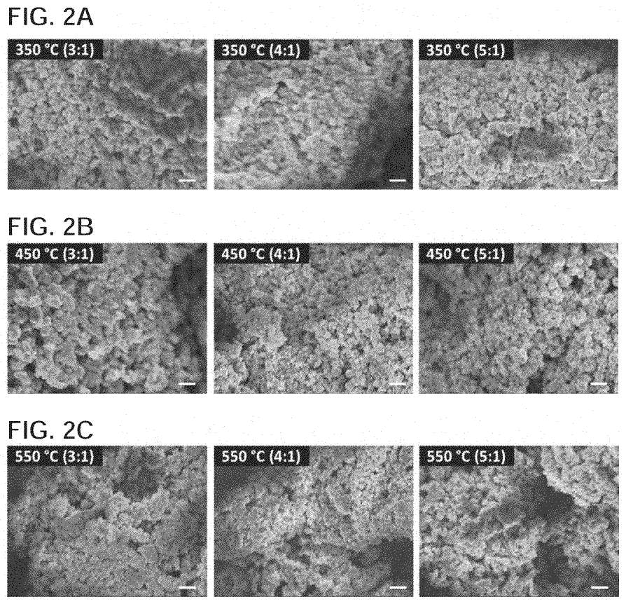

All composites produced existed as particulate clusters, in globular/spherical form, each typically less than one micrometer in diameter (FIGS. 2A-2C). No distinct morphological differences were otherwise seen for composites prepared at the respective temperatures or precursor weight ratios. Additional methods were further employed to study the chemical nature of the composites, as outlined below.

### Fourier-Transform Infrared Spectra of Sulfur-Polyacrylonitrile Composites

The chemical nature of the composites were then studied by Fourier-transform infrared (FTIR) spectroscopy for two reasons: (1) to ascertain chemical stability of the synthesized composite in the form of covalent bonding between sulfur and the composite (observed as C—S bonds), and (2) the prerequisite formation of an electrically conductive framework in the form of sp²-conjugated carbon and nitrogen (observed as C═C and C═N bonds).

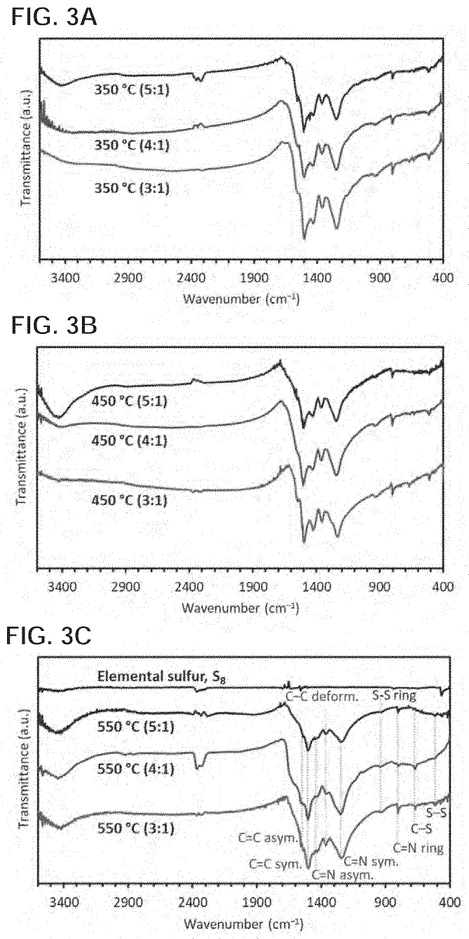

All composites displayed C—S bonding which confirmed covalently-bonded sulfur. However, only composites synthesized at 550° C. (FIG. 3C) showed more intense C═C bands relative to C—C deformations and C═N stretches, indicating a more extensive sp²-carbon network associated with higher conductivity. Exact peak absorptions are as detailed below.

FIGS. 3A-3C illustrate the characteristic FTIR spectra of S-PAN composites synthesized at varying temperatures and precursor weight ratios. The overall structures of the composites were similar, with several bonding modes seen between carbon, nitrogen, and sulfur. Exact absorptions at 512 cm⁻¹ and 940 cm⁻¹ indicate S—S stretching and S— S ring breathing modes respectively, while the 668 cm⁻¹ band for C—S stretching confirms new covalent bond formation between carbon and sulfur atoms in the composite. Bonding between carbon and nitrogen were also observed at 1240 cm⁻¹ and 1430 cm⁻¹ for symmetric and asymmetric C═N stretches, and at 800 cm⁻¹ corresponding to C═N hexahydric ring breathing. Additional bands were seen at 1360 cm⁻¹ associated with C—C deformations. A conjugated carbon backbone structure was also noted to exist with sp²-hybridized carbons with the presence of strong C═C symmetric and asymmetric bands at 1500 cm⁻¹ and 1550 cm⁻¹, suggestive of an sp² conjugated network which may confer electrical conductivity in the composite, as compared to both its insulating sulfur and PAN precursors. Nevertheless, closer inspection reveals an important difference between the materials produced at the different temperatures, where only composites synthesized at 550° C. showed comparatively less intense C—C deformations and C═N stretches relative to the C═C bands, which is associated with a more extensive sp²-carbon network.

### Elemental Analysis of Sulfur-Polyacrylonitrile Composites

As sulfur is itself the active species contributing to the capacity of the sodium-sulfur battery, the exact sulfur content was confirmed using elemental analysis. Elemental analysis reveals that the sulfur content of composites produced at 350° C. and 450° C. were fairly similar at approximately 40 wt. % regardless of the initial sulfur-to-PAN precursor ratio. However, composites synthesized at 550° C. had significantly lower sulfur contents overall, increasing slightly from 33.30% to 35.82% as the sulfur-to-PAN precursor ratio was increased. In addition, the hydrogen content of the composite carbonized at 550° C. from an initial 3:1 sulfur:PAN weight ratio was notably low at 0.32%, likely arising from a greater extent of sp²-hybridized carbons, in line with observations by FTIR spectroscopy. A monotonic increase in the hydrogen content was also noted for the 550° C. composites with increasing sulfur-to-PAN precursor ratios used.

TABLE 1
Elemental compositions of S-PAN
composites by combustion analysis

| Carbonization | Initial S-PAN | Elemental composition | | | |
|---|---|---|---|---|---|
| Temperature | weight ratio | C | H | N | S |
| 350° C. | 3:1 | 37.89 | 0.58 | 13.84 | 40.29 |
| | 4:1 | 36.63 | 0.51 | 12.84 | 41.84 |
| | 5:1 | 36.44 | 0.54 | 13.42 | 39.42 |
| 450° C. | 3:1 | 35.62 | 0.55 | 12.68 | 40.07 |
| | 4:1 | 38.00 | 0.69 | 14.97 | 39.67 |
| | 5:1 | 37.52 | 0.63 | 14.98 | 42.06 |
| 550° C. | 3:1 | 32.92 | 0.32 | 13.36 | 33.30 |
| | 4:1 | 34.56 | 0.57 | 15.44 | 33.74 |
| | 5:1 | 34.29 | 0.69 | 16.05 | 35.82 |

### Stability of the Sulfur-Polyacrylonitrile Composite Under Optimised Conditions

It is imperative that no unbound sulfur (i.e. elemental orthorhombic sulfur, S₈) exists in the synthesized composite, since its presence in a fabricated sodium-sulfur cell is detrimental to performance as a result of its high reactivity with the sodium anode. In this regard, thermogravimetric analysis was performed and the absence of free sulfur was confirmed, which would have otherwise been observed as a loss of sample weight at relatively low temperatures of about. 250-350° C.

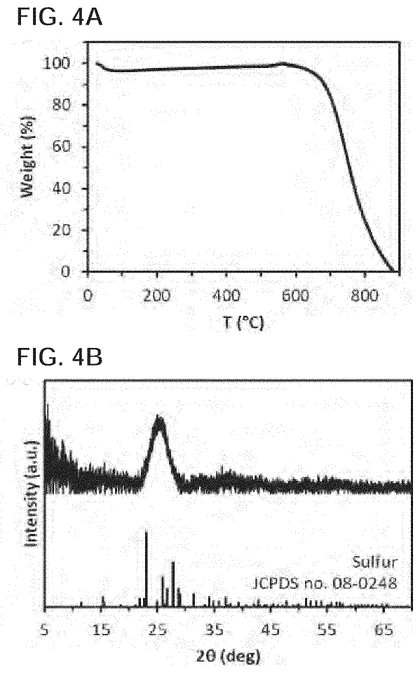

The optimised composite carbonized at 550° C. from an initial 3:1 sulfur:PAN weight ratio displayed good thermal stability up to around 650° C. (FIG. 4A), with decomposition only starting above this temperature, confirming the absence of free sulfur. Additionally, X-ray diffraction patterns of the composite displayed a broad peak at ca. 26° typical of graphitized carbons (FIG. 4b), without any of the characteristic peaks of elemental sulfur. Both techniques confirm that no free sulfur exists in the composite and all sulfur present is therefore directly bonded to the carbon-nitrogen backbone.

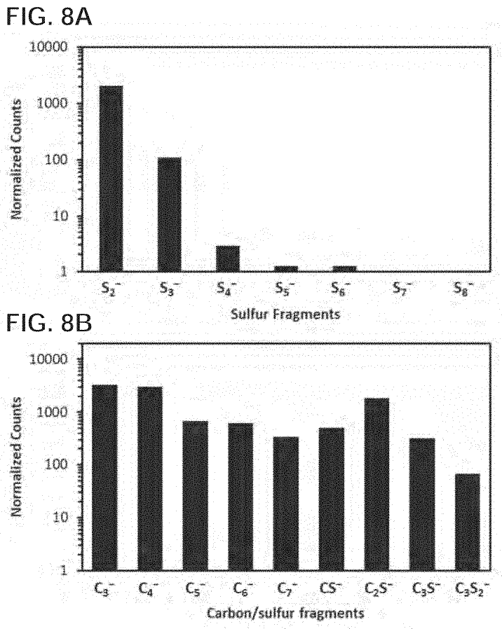

The absence of elemental sulfur was also confirmed in the optimized composite, as determined by time-of-flight secondary ion mass spectrometry (FIG. 8A). The sulfur chains were noted to exist primarily as short chain species S₂, S₃ and S₄.

### Example 3

### Fabrication of Full Cell Consisting of Sulfur-Polyacrylonitrile Composite Cathode and Sodium Anode

This Section describes a standard procedure for the preparation of batteries, but lends itself towards the fabrication of prototype sodium-sulfur full cells. Cells were assembled using cathode composites obtained from the invented synthetic method above in Section 1.1, and tested in combination with a new sodium trifluoromethanesulfonate (NaOTf) electrolyte salt, in various solvents.

S-PAN composites were ground in an agate mortar with conductive carbon (Super P), and mixed with polymer binder (polyvinylidene fluoride, PVDF) in a weight ratio of 7:2:1 with N-Methyl-2-pyrrolidone (NMP) solvent to yield a viscous slurry. Slurries were then coated onto carbon-coated aluminium foil with a doctor blade and allowed to dry completely at 70° C. Areal sulfur loadings were approximately between 0.4-0.6 mg₍ₛ₎·cm⁻².

Sodium-sulfur cells were fabricated as 2032-type coin cells. Assembly was done in an argon-filled glovebox with the respective S-PAN composites (11.28 mm diameter) used as the cathode. Freshly cut sodium blocks (99.9%) were rolled into sheets and cut into circular discs which served as the anode, separated by a Celgard membrane filled with 1 M sodium trifluoromethanesulfonate (NaOTf) electrolyte in a 1:1 volume solvent mixture of ethylene carbonate (EC) and diethyl carbonate (DEC). Other solvent combinations tested are as detailed in Table 2 below.

### Sodium-Sulfur Battery Performance

The stability of the optimised particulate composite has been demonstrated above. The stability and performance of the particulate S-PAN composite after its integration as cathode material in sodium-sulfur batteries is demonstrated below.

Cell fabrication and testing was done using a combination of sodium trifluoromethanesulfonate (NaOTf) as electrolyte salt, the S-PAN composite as cathode, in conjunction with a pure sodium anode. In light of the novel combination of the NaOTf electrolyte used with S-PAN cathodes, battery performances of the electrolyte were also evaluated in various solvents.

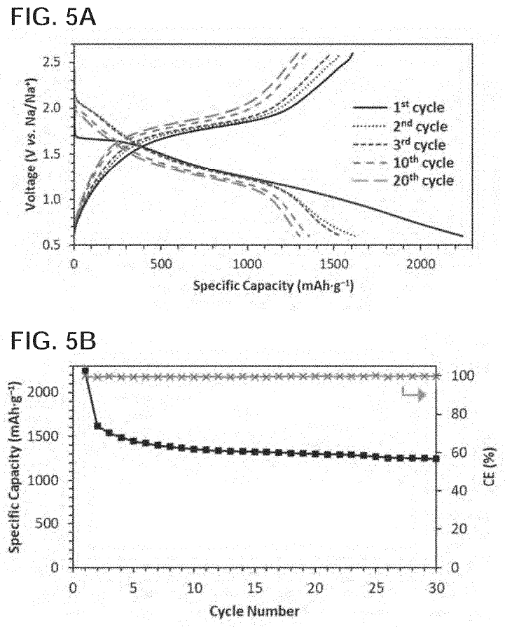

A battery prototype consisting of a S-PAN composite cathode was constructed with a pure sodium anode according to the method outlined in above section, and its performance tested by galvanostatic charge/discharge cycling at 0.2 C (where 1 C=1673 mA·g(S)-1, and specific capacity of sulfur=1673 mAh·g_{(S)}⁻¹). The composite carbonized at 550° C. from an initial 3:1 sulfur:PAN weight ratio was determined to be most stable. FIG. 5A illustrates the charge/discharge profiles of the S-PAN cathode in a 1 M sodium trifluoromethanesulfonate (NaOTf) electrolyte dissolved in a 1:1 volume mixture of ethylene carbonate (EC) and diethyl carbonate (DEC).

The initial discharge process begins from 1.7 V vs. Na/Na⁺, and the capacity was found to exceed the theoretical capacity of sulfur, reaching above 2200 mAh-g_{(S)}⁻¹. This additional capacity however, arises from the sodiation of the carbon-nitrogen backbone and is an irreversible process, occurring in conjunction with the conversion of sulfur to sodium sulfide (Na₂S). Upon the first charge cycle, the Na₂S discharge-product was reconverted back to sulfur.

The subsequent second discharge cycle then began at 2.1 V vs. Na/Na⁺, and a capacity of ca. 1600 mAh·g_{(S)}⁻¹ was recovered. Consequently, capacities were found to have stabilised by the tenth cycle at approximately 1350 mAh-g_{(S)}⁻¹, further maintaining 1250 mAh-g_{(S)}⁻¹ at the 30th cycle. Average Coulombic efficiencies also remained high at 99.6%, indicating good stability of sodium polysulfide intermediates in the presence of a highly reactive sodium metal anode.

Overall sodium-sulfur battery performance was further tested in different electrolyte solvents. In general for the S-PAN composites synthesized, better cycling performances were observed with carbonate-based solvents as compared to ether-based ones. As seen in FIGS. 5A-5C, a simple binary EC-DEC mixture allowed good capacity retention with high Coulombic efficiencies. No significant improvements were obtained with additives such as fluoroethylene carbonate (FEC) and vinylene carbonate (VC), or in mixtures with propylene carbonate (PC) solvent (Table 2). In particular, FEC and VC additives resulted in slightly lowered capacities, while unstable charge profiles were observed with PC-DEC or EC-PC mixtures along with reduced Coulombic efficiencies. Ether (glyme)-based solvents in general exhibited poor capacity retention, and unstable charge profiles.

TABLE 2
Battery cycling performance in various carbonate- and
ether (glyme)-based solvents or solvent combinations,
with 1M sodium trifluoromethanesulfonate electrolyte.

| | Cycling | Coulombic | |
|---|---|---|---|
| Solvent combinations | stability | Efficiency | Note |
| EC-DEC (1:1, v/v) | Good | ~100% | — |
| EC-DEC (1:1, v/v) with | Fair | ~100% | Low initial discharge |
| 5% FEC additive | | | capacity |
| EC-DEC (1:1, v/v) with | Fair | ~100% | Low initial discharge |
| 2% VC additive | | | capacity |
| EC-DMC (1:1, v/v) | Fair | ~100% | Occasional instability |
| | | | during charge cycle |
| EC-PC-DEC (1:1:2, v/v) | Good | ~100% | — |
| PC-DEC (1:1, v/v) | Poor | <100% | Unstable charge |
| | | (variable) | cycles |
| EC-PC (1:1, v/v) | Poor | <100% | Unstable charge |
| | | (variable) | cycles^{a} |
| Tetraglyme with 0.1M | Poor | <100% | Unstable charge |
| NaNO₃ additive | | (variable) | cycles |
| Tetraglyme | Poor | <100% | Unstable charge |
| | | (variable) | cycles |
| Diglyme | Poor | Low | Unstable charge |
| | | (variable) | cycles |
| Monoglyme | Poor | NA | Unable to discharge |

Notes:
^{a}glass fiber separator used in place of Celgard membrane.
Abbreviations: EC = ethylene carbonate, DEC = diethyl carbonate, DMC = dimethyl carbonate, FEC = fluoroethylene carbonate, VC = vinylene carbonate, PC = propylene carbonate, tetraglyme = tetraethylene glycol dimethyl ether, diglyme = diethylene glycol dimethyl ether, monoglyme = ethylene glycol dimethyl ether.

### Example 4

### Effects of Residual Elemental Sulfur, S₈

The effects of residual elemental sulfur were studied by comparing the morphology, chemical composition and electrical performance of composites which are substantially free of sulfur; and composites which comprise residual sulfur. The composite which is substantially free of sulfur was prepared according to the methods described herein (herein referred to as “evaporated” composite), while the composite comprising residual sulfur was prepared without the additional second heating step to evaporate sulfur (herein referred to as the “unevaporated” composite). Both composites were carbonized at 550° C. using an initial S:PAN weight ratio of 3:1.

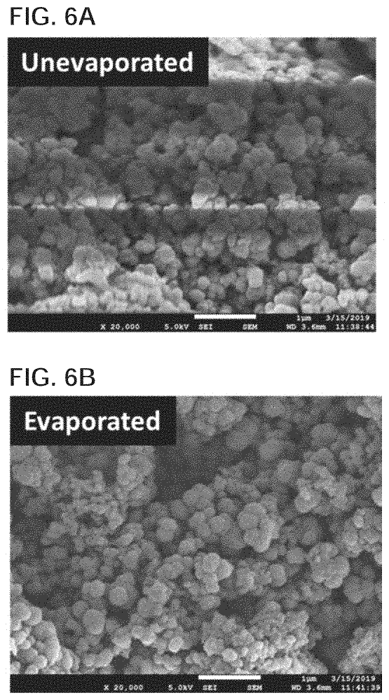

The morphology of the S-PAN composites first carbonized at 550° C. (S:PAN weight ratio of 3:1), with and without an additional sulfur evaporation process is shown in FIGS. 6A and 6B. In both materials, no change to the particulate morphology was observed as a result of the sulfur evaporation. It should however be noted that the composite without sulfur evaporation (FIG. 6B) exhibited localized charging effects in the scanning electron micrographs, associated with electrically non-conductive materials (e.g. elemental sulfur as an electrical insulator).

Elemental combustion analysis was further performed to measure the sulfur content of the composites, and the results are shown in Table 3 below. The composite prepared without the second heating step contained a larger amount of sulfur of above 40 wt % before evaporation.

TABLE 3
Sulfur content of S-PAN composites with and without sulfur evaporation
in inert gas flow, by elemental combustion analysis

| Composite Material | |
|---|---|
| T = 550° C., | Sulfur content |
| S-PAN ratio (3:1) | (wt. %) |
| Evaporated | 33.30 |
| Unevaporated | 46.55 |

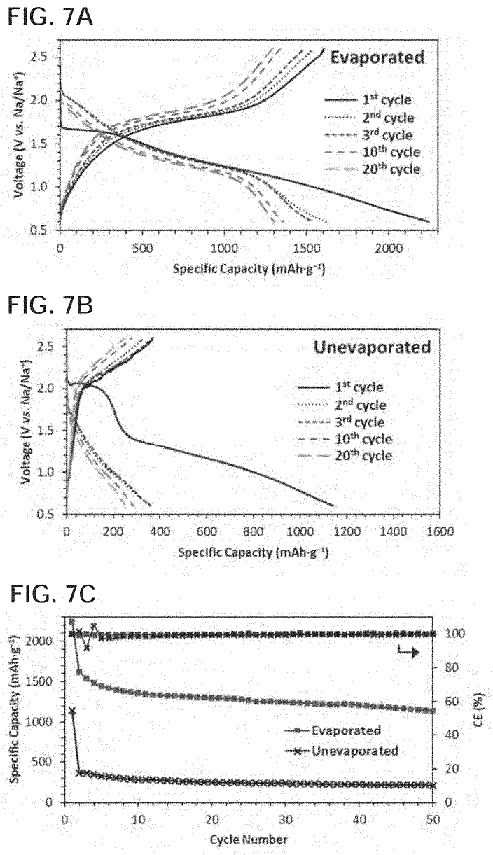

Finally, sodium-sulfur cells were assembled from both composites and tested FIGS. 7A-7C illustrate the typical galvanostatic charge/discharge profiles of surface-sulfur evaporated S-PAN in the sodium-sulfur system, with single sloping plateaus expected from the reaction of short-chain sulfur bonded to the composite. Contrastingly, the unevaporated composite displays a small initial plateau at a higher potential of 2.05 V vs. Na/Na⁺ in the first discharge cycle, followed by the usual sloping plateau. The high voltage plateau arises from the reaction of elemental sulfur in the composite with sodium ions, resulting in long-chain polysulfides that irreversibly dissolve into the electrolyte, resulting in an irreversible loss of capacity. As a result, a large decrease in capacity is observed from the second cycle, reaching below 400 mAh·g_{(S)}⁻¹. An unstable voltage profile was also seen in the subsequent re-charge, which might be attributed to the presence of reactive long-chain polysulfides in the electrolyte, and/or their passivation of the sodium anode. This instability could also be observed from the erratic Coulombic efficiencies of the first 5-7 cycles in the unevaporated composite (FIG. 7C), signifying the undesirable polysulfide shuttling effect. The average Coulombic efficiency over fifty cycles was also lower in the unevaporated composite at 99.2%, vs. 99.7% for the evaporated composite.

In light of the higher battery capacity and Coulombic efficiency of the surface-sulfur evaporated composite, it is thus demonstrated that the composite which is substantially free of elemental sulfur S₈, prepared with an additional step of heating for sulfur evaporation, significantly contributes to the overall improved electrochemical performance of S-PAN composites, specifically in the sodium-sulfur battery system.

### INDUSTRIAL APPLICABILITY

The disclosed carbonized composite may be used for the preparation of electrodes, such as cathodes which may be utilized in electrochemical cells. Due to its ease of manufacture, the carbonized composite disclosed herein may be conveniently prepared on an industrial scale.

The carbonized composite described herein may be used for the fabrication of sulfurized cathodes which are stable and operable at room temperature. Such cathodes are suitable for use in an electrochemical cell comprising an anode made from highly reactive metals such as sodium. In particular, the cathodes prepared with the carbonized composites may be coupled with a sodium anode, for the fabrication of sodium sulfur batteries. Sodium sulfur batteries are an alternative energy storage system to presently available technologies.

1. A carbonized composite comprising:
a) a sulfur chain;
b) a conductive network;
wherein said sulfur chain is covalently bonded to said conductive network via one or more C—S bonds;
wherein said composite is substantially free of S₈; and,
wherein said composite is provided in the form of clusters of particles, each particle having a diameter of 1 um or less.

2. The carbonized composite of claim 1, wherein said sulfur chain comprises 2-7 sulfur atoms.

3. The carbonized composite of claim 1, wherein said sulfur chain comprises 2-4 sulfur atoms.

4. The carbonized composite of claim 1, wherein said conductive network is a carbon-based conductive network.

5. The carbonized composite of claim 1, wherein said conductive network comprises a plurality of C═C and C═N bonds.

6. The carbonized composite of claim 5, wherein sulfur content of the composite is about 20 wt. % to about 50 wt. % of a total weight of the composite.

7. The carbonized composite of claim 6, wherein sulfur content of the composite is about 20 wt. % to about 40 wt. % of a total weight of the composite.

8. The carbonized composite of claim 7, wherein carbon content of the composite is about 20 wt. % to about 50 wt. % of a total weight of the composite.

9. The carbonized composite of claim 8, wherein the composite comprises less than 1 wt. % of hydrogen based on a total weight of the composite.

10. A method of preparing the carbonized composite of claim 9, the method comprising the steps of:
a) contacting elemental sulfur and a conductive network precursor to form a mixture, wherein an organic solvent is absent from the mixture;
b) heating the mixture obtained in step (a) at a temperature of 300° C. to 600° C. to form a composite; and
c) heating the composite under inert conditions under a temperature sufficient to remove bulk or unbonded sulfur to thereby obtain said carbonized composite.

11. The method of claim 10, comprising performing the heating step (b) at a temperature of about 550° C.

12. The method of claim 10, wherein the contacting step (a) comprises grinding particles of elemental sulfur and said polymer to form a homogenous mixture.

13. The method of claim 12, wherein comprising contacting the conductive network precursor and elemental sulfur at a weight ratio of 1:2 to 1:10.

14. The method of claim 10, wherein the conductive network precursor is a polymer.

15. The method of claim 14, wherein the conductive network precursor is a polymer comprising nitrile-functionalized monomer units.

16. The method of claim 14, wherein the polymer is polyacrylonitrile,

17. The method of claim 10, wherein comprising performing the heating step (b) for about 2 hours to about 10 hours.

18. The method of claim 10, comprising cooling the composite to room temperature after step (b) and before step (c).

19. The method of claim 10, wherein comprising carrying out the heating step (c) at a temperature of about 150° C. to about 300° C.

20. An electrochemical cell comprising:
a) a sodium anode;
b) a cathode comprising the carbonized composite as defined in claim 1; and
c) an electrolyte.
